(19) United States
(12) Patent Application Publication
(10) Pub. No.: US 2016/0142744 A1
(43) Pub. Date: May 19, 2016

(54) TRANSMISSION APPARATUS AND TRANSMISSION/RECEPTION SYSTEM

(71) Applicants: KABUSHIKI KAISHA TOSHIBA, Tokyo (JP); Toshiba Lifestyle Products & Services Corporation, Tokyo (JP)

(72) Inventors: Atsushi HIROTA, Yokohama Kanagawa (JP); Masahiro YAMADA, Nishitama Tokyo (JP)

(21) Appl. No.: 14/884,668

(22) Filed: Oct. 15, 2015

(30) Foreign Application Priority Data
Nov. 17, 2014 (JP) 2014-233150

(51) Int. Cl. H04N 21/2362; H04N 21/2343; H04N 21/482; H04N 21/434; H04N 21/438; H04N 21/4402; H04N 21/236; H04N 21/235

(52) U.S. Cl. CPC H04N 21/2362; H04N 21/23614; H04N 21/234363; H04N 21/2353; H04N 21/4345; H04N 21/4383; H04N 21/440218; H04N 21/4821

(57) ABSTRACT

According to one embodiment, a transmission apparatus including, a control information generator for generating channel select control information indicative of configuration information for transmission, the configuration information comprising content included in a first video signal transmitted via a different transmission path than a second video signal, and a multiplexer that multiplexes the second video signal and the channel select control information, the second video signal obtained based at least in part on a base video signal, the second video signal corresponding to the channel select control information.

### CROSS-REFERENCE TO RELATED APPLICATIONS

This application is based upon and claims the benefit of priority from Japanese Patent Application No. 2014-233150, filed Nov. 17, 2014, the entire contents of which are incorporated herein by reference.

### FIELD

Embodiments described herein relate generally to a transmission apparatus and a transmission/reception system.

### BACKGROUND

It has recently been proposed to introduce, into, for example, domestic satellite broadcasts, a so-called 4K broadcast (3840×2160) or 8K broadcast (7680×4320) that has horizontal and vertical resolutions four or eight times the resolutions of a current high-definition (HD) (2K) broadcast.

However, in order to introduce the 4K broadcast or 8K broadcast with the current broadcast maintained, it is necessary to secure a new broadcast band of a large capacity. Further, when a current broadcast company provides 4K/8K broadcast services, costs for program production and/or services may be increased because the broadcast systems use different video resolutions or coding schemes.

In view of this, it has been proposed to employ, for example, Scalable High efficiency Video Coding (SHVC) (scalable HEVC) extendedly defined in High efficiency Video Coding (ISO/IEC23008-2), the 2nd edition, which is the latest video coding scheme standards standardized in Moving Picture Experts Group (MPEG) in July, 2014. More specifically, SHVC is a scheme where MPEG-2 Video coding for HD signals is used as a base scheme, and decoded images corresponding to the HD signals are also extendedly used as reference images for HEVC coding of 4K/8K signals.

When such new services are added, extended and introduced, some existing receivers may perform unexpected operations, which means that it may be difficult to introduce added and extended services with the current broadcast specifications maintained.

Further, in receivers complying with the 4K/8K broadcasts, when receiving and reproducing signals based on, for example, the SHVC scheme, real-time processing of a main channel (current broadcast signal) and a sub-channel (extended broadcast signal) is performed in a parallel manner, and hence efficient and smooth processing is needed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a transformation/reception system according to an embodiment;

FIG. 2 shows an example of a transmission signal processing system incorporates in a transmitter according to the embodiment;

FIG. 3 shows an example of a normal PMT data structure according to the embodiment;

FIG. 4 shows an example of a data structure of an ES reference descriptor according to the embodiment;

FIG. 5 shows an example of a receiver according to the embodiment;

FIG. 6 shows an example of a restoration processor incorporated in a signal processor in the receiver according to the embodiment;

FIG. 7 is a schematic view for explaining reference to ESs between different transmission paths and transmission schemes according to the embodiment;

FIG. 8 shows an example of a channel select processing performed by the receiver according to the embodiment;

FIG. 9 shows an example of a relationship between a main channel and a sub-channel according to the embodiment;

FIG. 10 shows an example of a data structure of a service group descriptor newly defined according to the embodiment;

FIG. 11 shows an example of a channel select list generation processing in a receiver according to the embodiment;

FIG. 12 shows an example of a relationship between channel select control processing associated with a main channel and that associated with a sub-channel according to the embodiment;

FIG. 13 shows an example of a relationship between channel select control processing associated with the main channel and that associated with the sub-channel according to the embodiment;

FIG. 14 shows an example of a transformation/reception system according to the embodiment;

FIG. 15 shows an example of a relationship between a main channel and a sub-channel according to the embodiment; and

FIG. 16 shows an example of an electronic guide screen as a program table in a receiver according to the embodiment.

### DETAILED DESCRIPTION

Various embodiments will be described hereinafter with reference to the accompanying drawings.

In general, according to one embodiment, a transmission apparatus comprising: a control information generator for generating channel select control information indicative of configuration information for transmission, the configuration information comprising content included in a first video signal transmitted via a different transmission path than a second video signal; and a multiplexer that multiplexes the second video signal and the channel select control information, the second video signal obtained based at least in part on a base video signal, the second video signal corresponding to the channel select control information.

Embodiments will now be described hereinafter in detail with reference to the accompanying drawings.

### First Embodiment

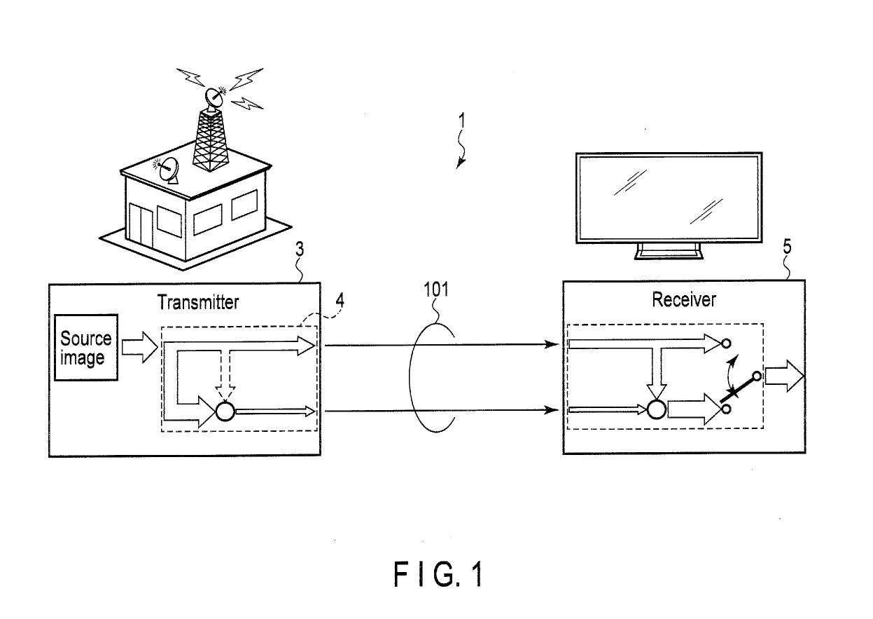

FIG. 1 is a schematic view showing an example of a transformation/reception system 1 according to a first embodiment.

As shown, the transformation/reception system 1 of the first embodiment comprises a transmitter (transmission apparatus) 3, a receiver (reception apparatus) 5 and a server 7. In the transformation/reception system 1, the transmitter 3, the receiver 5 and the server 7 are connected to each other by a broadcasting and communication path, wirelessly and/or wired. In the transformation/reception system 1, the transmitter 3 distributes program content via broadcasting waves as a medium.

The transmitter 3 attaches various types of information to each input source image to thereby generate content (TV programs (broadcast programs), satellite broadcast programs, distribution content, video and still images, music data, programs, etc.), and transmits it as video signals. The source image is a high-quality video image (first high-quality video signal) obtained by an image pickup device, such as a camera. The transmitter 3 is constructed by applying Scalable High efficiency Video Coding (SHVC) to High-definition (HD) broadcasting. As shown in FIG. 1, in the SHVC broadcasting, the transmitter 3 converts content into a plurality of signals, and transmits the signals through different paths included in a transmission path 101. The transmission path includes a band, a circuit, etc., for transmitting signals, and may include a plurality of paths. In the first embodiment, the transmission path 101 includes two paths. The transmitter 3 outputs signals, obtained by converting content through respective predetermined conversion schemes, to the two paths included in the transmission path 101. At this time, the transmitter 3 transmits the signals to the two paths using different transmission schemes corresponding to the conversion schemes. The transmission schemes include various types of means (formats) associated with signal transmission and including broadcasting schemes, encoding schemes, transmission routes, transmission methods, transmission bands and types of lines, etc. For instance, the transmitter 3 generates, from an input source image, an HD (2K) video image (still image) (i.e., a reference video signal (first video signal)) and a complementary video image (still image) (resolution-enhanced video signal (second video signal)) for 4K HD video image. The transmitter 3 transmits the reference video signal and the resolution-enhanced video signal through different paths and/or different transmission schemes.

The receiver 5 receives content distributed from the transmitter 3 through satellite and/or ground (terrestrial digital) broadcasting, and displays the received content. A video signal as a main channel and a display signal (first display signal) for the video signal, which are received by the receiver 5 and are included in the content to be displayed, may be called a main channel, a main service, a main channel transport stream (TS), a current broadcast signal, or the like. Similarly, a video signal as a sub-channel and a display signal (second display signal) for the video signal may be called a sub-channel, a sub-service, a sub-channel TS, a high-quality video signal, a 4K video signal, a resolution-enhanced service, a resolution-enhanced broadcast signal, or the like.

The receiver 5 is, for example, a television (TV) receiver, a personal computer (PC), a home server, a recorder, etc. In the first embodiment, the receiver 5 is a TV compatible with 2K (2K1K), 4K (4K2K) and/or 8K (8K4K). For facilitating the description below, the receiver 5 will be described as a TV compatible with 2K/4K.

(Transmitter)

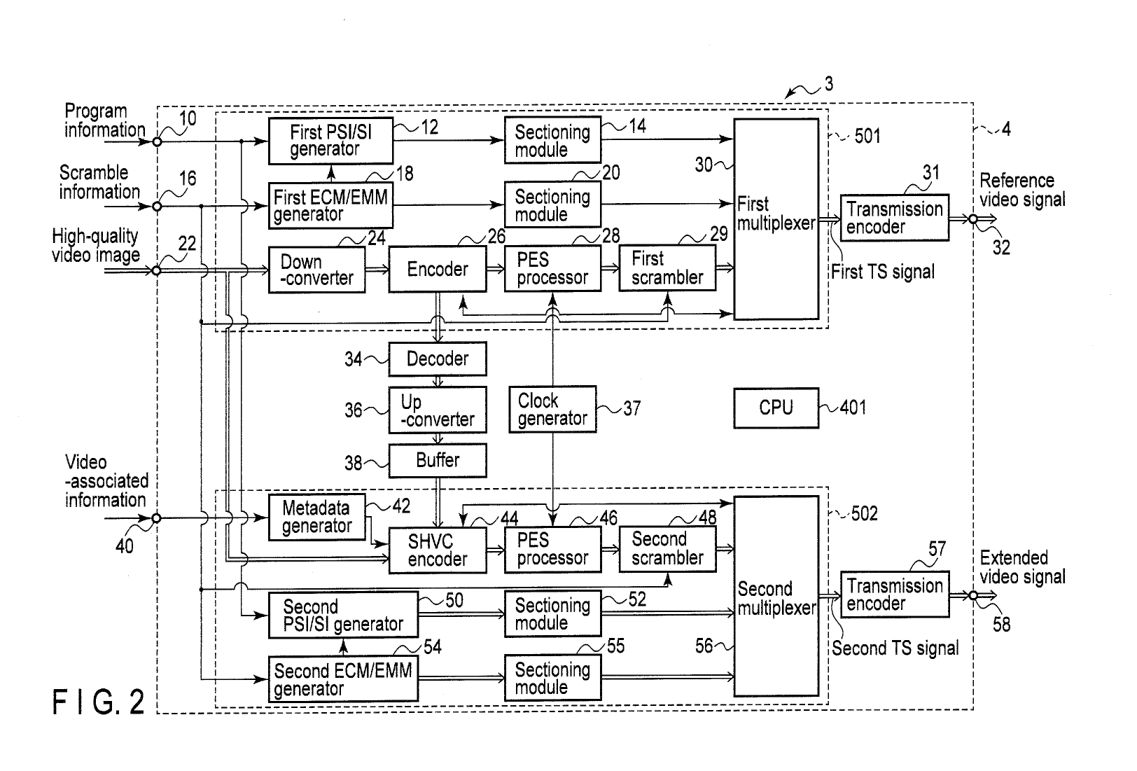

FIG. 2 is a block diagram showing an example of a transmission signal processing system incorporated in the transmitter 3. As shown, the transmitter 3 comprises a transmission signal processor 4. The transmission signal processor 4 is a signal processor for transmission. Although the transmission signal processor 4 also comprises processors for audio signals and data signals, they are not shown for simplification. In FIG. 2, each double line indicates the input/output of a content signal, such as a signal including a video signal, and each solid line indicates the input/output of a signal including no video signal, such as a signal including a control signal or a data signal.

A description will be given of the configuration of the transmission signal processor 4.

The transmission signal processor 4 comprises a plurality of input terminals for inputting various types of signals. The transmission signal processor 4 also comprises a decoder 34, an up-converter 36, a buffer 38, a clock generator 37, a central processing unit (CPU) (first controller) 401, a first signal generator 501, a second signal generator 502, transmission encoders 31 and 57, and output terminals 32 and 58.

In the first embodiment, the transmission signal processor 4 further comprises input terminals 10, 16, 22 and 40. In the first embodiment, the input terminal 10 is used to input a signal indicative of program information. The input terminal 16 is used to input a signal indicative of scramble information. The input terminal 22 is used to input a signal indicative of a high-quality video signal (first high-quality video signal) as a base video signal, such as a 4K video signal. The high-quality video signal indicates a plurality of high-quality images arranged at predetermined intervals in a time-series manner. In the description below, it is assumed that video images include still images. The input terminal 40 is used to input a signal indicative of video-related information. The program information, scramble information, high-quality video signal, video-related information and other information may be included in content when they are input. In this case, the transmitter 3 separates the program information, scramble information, high-quality video signal, video-related information and other information from the content, and sends them to the transmission signal processor 4. The program information, scramble information, high-quality video signal, video-related information and other information, which constitute the content, may be also referred to as the configuration information. Further, a high-quality video signal and high-quality broadcasting signal, which are synthesized with the configuration information, may be referred to as high-quality content.

The decoder 34 decodes various types of signals (time information, data signals, video signals, etc.). The decoder 34 is, for example, an MPEG-2 decoder. In this case, the decoder 34 decodes signals encoded by MPEG-2 coding.

The up-converter 36 up-converts the resolution, screen size and color band of an input video signal. For instance, the up-converter 36 up-converts the video signal (first decoded video signal), decoded by the decoder 34, into a first resolution-enhanced, decoded signal (indicative of a reference video or still image), and outputs the first resolution-enhanced, decoded video signal. For instance, the up-converter 36 converts an input decoded signal of 2K into a first resolution-enhanced, decoded video signal of 4K.

The buffer 38 is a memory area circuit for temporarily accumulating various signals.

The clock generator 37 generates first clock information for synchronization, and time information indicative of the time of reproduction and display. The time information includes, for example, a presentation time stamp (PTS), decoding time stamp (DTS), system time clock (STC), system clock reference (SCR), etc.

The CPU (first controller) 401 is a circuit configured to control the entire transmission signal processor 4. Namely, the CPU 401 controls the first signal generator 501, the second signal generator 502, the decoder 34, the up-converter 36, the buffer 38 and the clock generator 37.

The first signal generator 501 generates a signal (a reference video signal, a first TS signal) constituting a main channel. The second signal generator 502 generates a signal (a resolution-enhanced video signal, resolution-enhanced data, a second TS signal) constituting a sub-channel as a high-quality video signal for complementing the main channel. The first and second signal generators 501 and 502 use the same system time clock (STC). The first signal generator 501 is configured to comply with current TV broadcasting, for example, HD broadcasting. For instance, the first signal generator 501 may have substantially the same structure as a transmitter for the current TV broadcasting.

The first signal generator 501 receives signals through the input terminals 10, 16 and 22, and generates the first TS signal for the main channel. For instance, the first signal generator 501 applies MPEG-2 Video coding to an input reference video signal. In this case, the first signal generator 501 generates a reference video signal based on the MPEG-2 Video coding.

The second signal generator 502 receives signals through the input terminals 10, 16, 22 and 40, and generates, from an input source image, a resolution-enhanced video signal constituting part of the sub-channel. For instance, the second signal generator 502 applies MPEG-HEVC Video coding to an input signal. In this case, the second signal generator 502 generates a resolution-enhanced video signal based on SHVC for complementing a 4K video signal and a 2K video signal.

The configurations of the first and second signal generators 501 and 502 will be described later.

The transmission encoders 31 and 57 execute modulation and error correction coding corresponding to the respective transmission paths, and output resultant signals through the output terminals 32 and 58, respectively. The transmission encoders 31 and 57 may be incorporated in the first and second signal generators 501 and 502, respectively, as will be described later.

The configurations of the first and second signal generators 501 and 502 will now be described.

Firstly, the configuration of the first signal generator 501 will be described.

The first signal generator 501 comprises a first Program Specific Information (PSI)/Service Information (SI) generator 12, a first Entitlement Control Message (ECM)/Entitlement Management Message (EMM) generator 18, sectioning modules 14 and 20, a down-converter 24, an encoder 26, a Packetized Elementary Streaming (PES) processor 28, a first scrambler 29 and a first multiplexer 30.

The PSI/SI generator 12 generates program specific information (PSI) corresponding to input program information, and service information (SI), and outputs the generated PSI and SI. The PSI is data for various types of control information, such as information used to decode (reproduce) content transmitted by a TS stream (TS signal) and an Elementary Stream (ES) (component) included in the content, and information for scrambling. Namely, the PSI includes, for example, information used to associate video and audio signals, subtitle/character, information, etc., with each other as multiplexing transmission control information for respective programs, to multiple-separate signals constituting a selected program at the time of reception/reproduction, and to synchronize and reproduce associated signals and information signals with good timing.

The PSI and SI include Program Association Table (PAT), Program Map Table (PMT), Network Information Table (NIT) and Conditional Access Table (CAT), etc. The PAT is information for managing a program included in a stream. The PMT is information for managing data, such as audio/video (A/V) data constituting content (a TV program, a program). The NIT is information for managing network-associated settings, and includes information associated with a network, such as a channel number, a modulation scheme and a guard interval. The CAT is management information for pay-broadcasting. For facilitating the description, the SI may be expressed as the PSI since it is a part of the PSI.

The first ECM/EMM generator 18 generates common information (ECM) including, for example, information associated with content, information indicative of whether the content is viewable, and information associated with control of the receiver, and individual information (EMM) including personal engagement information and information for decrypting a cipher for the common information. The first ECM/EMM generator 18 generates a first ECM and a first EMM in accordance with a first transmission path and a first transmission scheme, respectively. The first ECM/EMM generator 18 encrypts, for example, the first EMM including a work key, using a master key, and encrypts the first ECM including a scramble key, using the work key.

The sectioning modules 14 and 20 divide various signals in content into sections. The section is a type of format that can be transmitted via a TS.

The down-converter 24 down-converts the resolution, screen size and color band of an input signal. For instance, the down-converter 24 converts the resolution of an input 4K video signal into that of a 2K video signal, and converts the color band of the 4K video signal into a color band appropriate for the 2K video signal.

The encoder 26 executes compression and encoding of an input signal. The encoder 26 is, for example, an MPEG-2 encoder. In this case, the encoder 26 encodes an input video signal using the MPEG-2 coding scheme.

The PES processor 28 converts, into a packet, a signal input thereto in accordance with a first clock signal received from the clock generator 37, and adds time information to the packet signal.

The first scrambler 29 encrypts an input signal. The first scrambler 29 encrypts the input signal in accordance with, for example, the first transmission path and the first transmission scheme, using a scramble key. The first scrambler 29 executes encryption using MULTI 2.

The first multiplexer 30 subjects various signals to TS packet multiplexing, thereby generating TS signals (first TS signals).

The second signal generator 502 will be described.

The second signal generator 502 comprises a metadata generator 42, an SHVC encoder (resolution-enhanced-signal generator) 44, a second PSI/SI generator (channel select control information generator) 50, a second ECM/EMM generator 54, sectioning modules 52 and 55, a PES processor 46, a second scrambler 48 and a second multiplexer 56.

The metadata generator 42 generates metadata (meta information), such as contrast, a color band and a gradation characteristic. The metadata generator 42 generates metadata associated with high-quality content, such as a 4K video image.

The SHVC encoder 44 executes compression and encoding of an input signal. The SHVC encoder 44 encodes a signal input by the SHVC scheme (scalable coding scheme). In the SHVC scheme, the SHVC encoder 44 can execute inter prediction (motion compensation prediction), intra-prediction (prediction within a screen) or inter-prediction (prediction between layers or images). Among these prediction methods, the SHVC encoder 44 can execute optimal prediction under the control of a CPU 401.

For instance, in the SHVC scheme, inter prediction is executed for predicting an extension layer (such as a 4K resolution-enhanced video image) that provides a TV video image for high-quality broadcasting, from a reference layer (such as a 2K reference video image) that provides a current TV video image, as well as inter-screen prediction and prediction within a screen employed in the HEVC scheme. Since a video image obtained by up-converting a decoded reference layer can be used as a candidate for prediction, a higher compression ratio may be obtained than in the case of directly compressing a high-quality video image, such as a 4K image.

For instance, the SHVC encoder 44 generates a signal corresponding to a resolution-enhanced/predicted image, based on inter-prediction between a high-quality image and a reference image, by synchronizing the same images included in an input high-quality image signal and a first resolution-enhanced, decoded image, referring to an image (reference image) included in a first extension decode signal, and executing inter-prediction between the high-quality image (reference layer) and the reference image (extension layer). Further, the SHVC encoder 44 adds metadata acquired from the metadata generator 42 to the image corresponding to the resolution-enhanced/predicted-image. The SHVC encoder 44 arranges the generated resolution-enhanced image signals at regular interfaces in a time-series manner, thereby generating a resolution-enhanced, predicted video image. The SHVC encoder 44 encodes the resolution-enhanced/predicted image using the scalable coding (SHVC coding), thereby generating an extension signal (scalable signal) and outputting the encoded scalable signal obtained by scalable coding. The SHVC encoder 44 can also generate an resolution-enhanced/predicted video image using a prediction scheme other than the inter-prediction.

The second PSI/SI generator 50 generates program specific information (PSI) and service information (SI) from input program information in accordance with a second transmission path and a second transmission scheme. Namely, the first and second PSI/SI generators 12 and 50 generate PSI/SI for the same content (or the source image) corresponding to the transmission path and transmission scheme. Further, in accordance with an instruction signal from the CPU 401, the second PSI/SI generator 50 newly defines, as information (signal) for a predetermined video signal, a descriptor (first channel select control information (first channel select control descriptor)) that enables configuration information concerning a signal transmitted by a different transmission path and/or a different transmission scheme to be referred to. The second PSI/SI generator 50 newly defines, within a PMT included in the PSI of a content TS, a descriptor (first channel select control information (first channel select control descriptor)) that enables the ES of a signal transmitted by a different transmission path and/or a different transmission scheme to be referred to. Furthermore, in accordance with an instruction signal from the CPU 401, the second PSI/SI generator 50 can also arbitrarily set a signal indicative of, for example, content or the source image, to which the descriptor is imparted.

A description will now be given of the descriptor newly defined by the second PSI/SI generator 50.

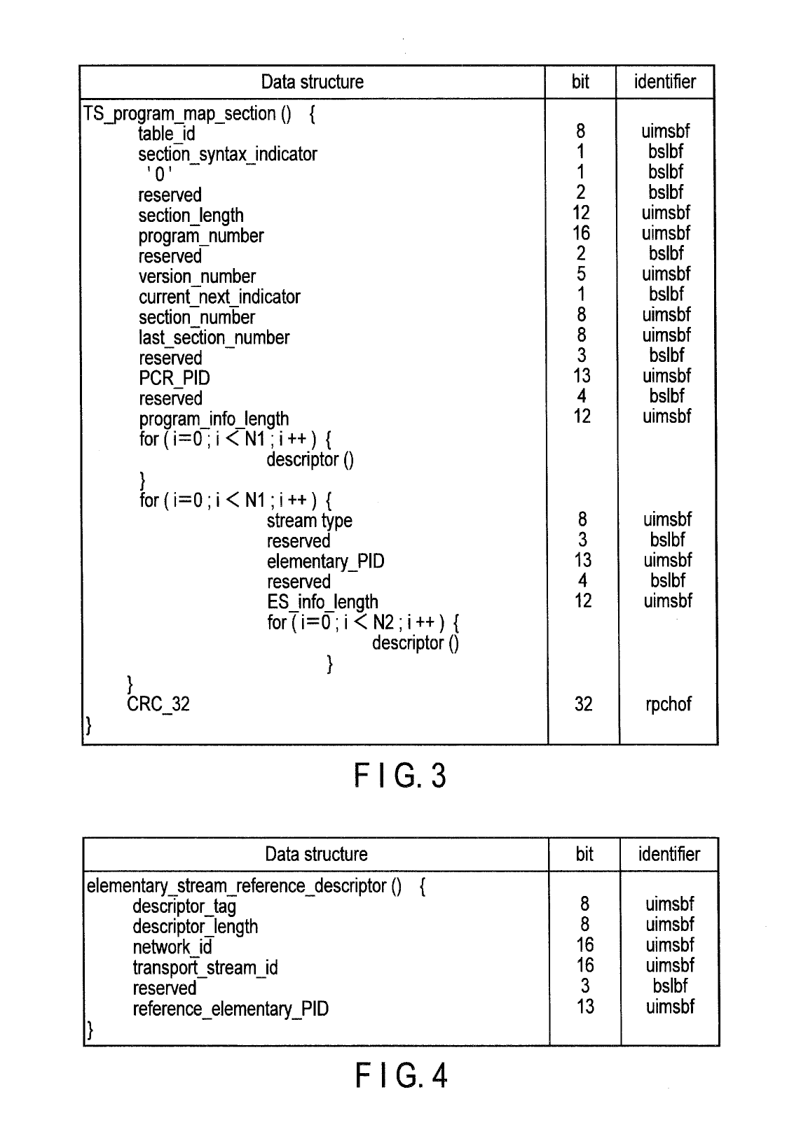

FIG. 3 shows the data structure of a general PMT. The PMT data structure shown in FIG. 3 is defined in Association of Radio Industries and Businesses (ARIB) STD-B10, as program arrangement information standards for digital broadcasting.

The second PSI/SI generator 50 sets a PMT so that the receiver 5, described later, can recognize that an ES in a signal transmitted by a different transmission path and/or a transmission scheme is designated. For instance, the second PSI/SI generator 50 sets an invalid PID (packet ID) value (0x1FFF) in elementary_PID in the data structure of the PMI shown in FIG. 3.

FIG. 4 shows a data structure example of an ES reference descriptor newly defined.

In the first embodiment, the second PSI/SI generator 50 newly defines, under the name of “elementary_stream_reference_descriptor( ),” and writes, in the ES reference descriptor, “network_id” for allowing the ES of a different transmission path to be referred to, and “transport_{—} stream_{—} id” for allowing the ES of a different transmission scheme to be referred to.

The second ECM/EMM generator 54 generates an ECM and an EMM in accordance with the second transmission path and the second transmission scheme. Namely, the first and second ECM/EMM generators 18 and 54 generate ECMs and EMMs for the same content corresponding to the first and second transmission paths and transmission schemes, respectively. The second ECM/EMM generator 54 generates the second ECM and the second EMM in accordance with the SHVC scheme, such as the resolution-enhanced 4K broadcasting scheme. The first ECM/EMM generator 18 encrypts the second EMM including a work key, using a master key, and encrypts the second ECM including a scramble key, using the work key.

The sectioning modules 52 and 55 section respective input signals.

The PES processor 46 processes, to form a packet, a signal input thereto in accordance with the first clock signal from the clock generator 37, and adds time information to the signal as the packet.

The second scrambler 48 encrypts the input signal. The second scrambler 48 encrypts the input signal in accordance with the second transmission path and the second transmission scheme, using a scramble key. More specifically, the scrambler 48 encrypts the signal using, for example, Advanced Encryption Standard (AES). The second multiplexer 56 subjects the signal to TS packet multiplexing to generate a TS signal (second TS signal). The second PSI/SI generator 50 generates PSI and SI.

In the transmitter 3 of the first embodiment, the transmission signal processor 4 receives program information, scramble information, a high-quality video signal and video-associated information via the input terminals 10, 16, 22 and 40, respectively. In the transmission signal processor 4, various signals input thereto are supplied to the first and second signal generators 501 and 502.

In the first signal generator 501, the first PSI/SI generator 12 obtains the program information, and the first ECM/EMM generator 18 obtains the scramble information. The first ECM/EMM generator 18 generates an ECM (first ECM) and an EMM (first EMM) from the obtained scramble information, and outputs them to the first PSI/SI generator 12 and the sectioning module 20. The sectioning module 20 sections the obtained ECM and EMM information (signals) and outputs them to the first multiplexer 30.

The first PSI/SI generator 12 generates PSI and SI from the obtained program information, ECM and EMM, and outputs them to the sectioning module 14. The sectioning module 14 sections the obtained PSI and SI information (signals) and outputs them to the first multiplexer 30.

The down-converter 24 obtains a high-quality video signal as a base video signal, down-converts the obtained high-quality video signal into a resolution-reduced video signal, and outputs the resolution-reduced video signal to the encoder 26. For instance, the down-converter 24 converts a 4K video signal into a 2K video signal, and outputs the conversion result (resolution reduction result) o the encoder 26. The encoder 26 encodes the resolution-reduced video signal to thereby generate an encoded signal. The encoder 26 outputs the generated encoded signal to the PES processor 28 and the decoder 34. The encoder 26 encodes a 2K video signal using, for example, MPEG-2 coding, and outputs the encoded signal.

The PES processor 28 converts the obtained encoded signal into an encoded packet signal and adds time information to the encoded packet signal. Further, the PES processor 28 sequentially outputs, to the first scrambler 29, the encoded packet signal in accordance with the first clock information from the clock generator 37. The first scrambler 29 encrypts the encoded packet signal to form an encrypted packet signal (first encrypted packet), and outputs the encrypted signal to the first multiplexer 30.

The first multiplexer 30 multiplexes the first encrypted packet from the scrambler 29 with the signals from the sectioning modules 14 and 20 (TS packet multiplexing) to form a TS signal (first TS signal), and outputs the first TS signal to the transmission encoder 31. The transmission encoder 31 executes modulation and error correction encoding on the first TS signal in accordance with the first transmission path, and outputs the first TS signal as a broadcast signal via the output terminal 32. The CPU 401 controls, for example, the output timing of the encoder 26 and the first multiplexer 30.

The encoded signal output from the encoder 26 is input to the decoder 34. The decoder 34 decodes the received encoded signal into a first decoded video signal, and outputs the first decoded video signal to the up-converter 36. For instance, the decoder 34 decodes the encoded signal into a 2K video signal, using the MPEG-2 scheme. The up-converter 36 up-converts the received decoded signal, such as the 2K video signal, into a first resolution-enhanced decoded signal, such as a first resolution-enhanced 4K video signal, and outputs the resultant signal to the buffer 38. The buffer 38 temporarily accumulates the received first resolution-enhanced decode video signal, and outputs it to the SHVC encoder 44 of the second signal generator 502.

In the second signal generator 502, the second PSI/SI generator 50 obtains the program information, and the second ECM/EMM generator 54 obtains the scramble information. The second ECM/EMM generator 54 generates an ECM (second ECM) and an EMM (second EMM) from the obtained scramble information, and outputs them to the second PSI/SI generator 50 and the sectioning module 55. The sectioning module 55 sections the obtained ECM and EMM information (signals) and outputs them to the second multiplexer 56.

The second PSI/SI generator 50 generates PSI (second PSI) and SI (second SI) from the obtained program information, the second ECM and the second EMM, and outputs them to the sectioning module 52, for predetermined content or a predetermined source image in accordance with an instruction from the CPU 401. At this time, the second PSI/SI generator 50 sets invalid PID value (0x1FFF) in elementary_PID within the data structure of the PMT. Further, the second PSI/SI generator 50 newly defines, under the name of “elementary_stream_reference_descriptor( ),” and writes, in the ES reference descriptor, “network_id” for allowing the ES of a different transmission path to be referred to, and “transport_{—} stream_{—} id” for allowing the ES of a different transmission scheme to be referred to. The sectioning module 52 sections the obtained PSI and SI information (signals) and outputs them to the second multiplexer 56.

The metadata generator 42 obtains video-associated information, generates metadata and outputs the metadata to the SHVC encoder 44.

The SHVC encoder 44 generates resolution-enhanced, predicted signals by synchronizing the same images included in the input high-quality video signal and the first resolution-enhanced video signal, and executing inter-prediction between the high-quality image and a reference image. The SHVC encoder 44 further generates a resolution-enhanced, predicted video image from the generated, resolution-enhanced, predicted image signals by arranging these signals at predetermined intervals in a time-series manner. The SHVC encoder 44 converts a resolution-enhanced, predicted video image into a scalable signal (resolution-enhanced signal) using scalable coding, and outputs the scalable signal to the PES processor 46. The PES processor 46 adds time information to the scalable signal to thereby make the signal in the form of a packet, thereby generating a scalable packet signal. The PES module sequentially outputs the scalable packet signal to the second scrambler 48 in accordance with the first clock information. The second scrambler 48 encrypts the scalable packet signal to form an encrypted packet signal (second encrypted packet), and outputs the second encrypted packet to the second multiplexer 56.

The second multiplexer 56 subjects signals obtained from the sectioning module 14, the sectioning module 20 and the first scrambler 29 to TS packet multiplexing, thereby generating a TS signal (second TS signal), and outputting the second TS signal to the transmission encoder 57. The transmission encoder 57 performs, on the second TS signal, modulation and error correction encoding corresponding to the second transmission path, and outputs the resultant second TS signal as an extended video signal via the output terminal 58.

The resolution-enhanced video signal as a signal for constituting a sub-channel is transmitted through a transmission path different from that for the reference video signal constituting a main channel.

(Receiver)

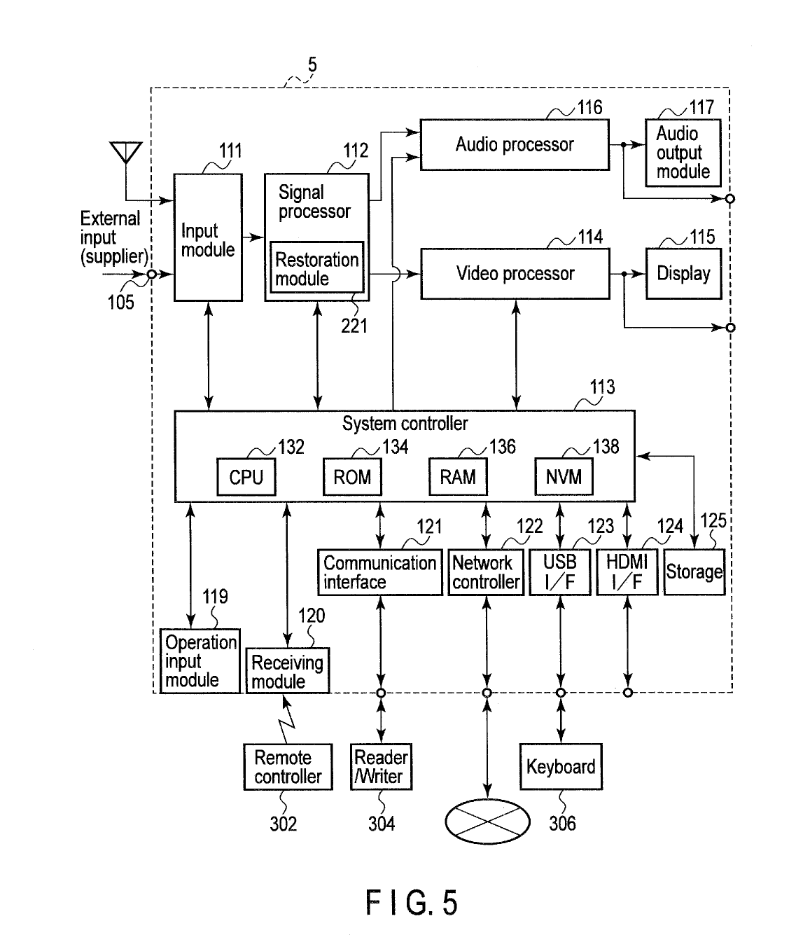

FIG. 5 is a block diagram showing an example of the receiver 5.

As shown, the receiver 5 of the first embodiment comprises an external input terminal 105, an input module 111, a signal processor 112, a system controller (system control unit) 113, a video processor 114, a display 115, an audio processor 116, an audio output module 117, an operation input module 119, a receiving module 120, a communication interface 121, a network controller 122, a Universal Serial Bus (USB) interface 123, a High-Definition Multimedia Interface (HDMI) (trademark) 124 and a storage 125.

The external input terminal 105 is a terminal for connection with a dedicated line, a terminal device and/or an external device.

The input module 111 comprises, for example, an antenna for receiving broadcasts, and a tuner for selecting a received signal. In the first embodiment, the input module 111 includes a plurality of tuners, for example, two tuners corresponding to broadcast signals and resolution-enhanced broadcast signals. The input module 111 is connected to the antenna for receiving programs supplied by broadcasting enterprises via a broadcasting line and/or space waves. The input module 111 also receives content (for example, programs) supplied via a transmission path or a network. The input module 111 receives broadcast streams (broadcast signals and resolution-enhanced signals), selects one or more broadcast programs, and converts them into a broadcast stream usable in the signal processor 112. The input module 111 transmits, to the signal processor 112, all received content (for example, programs) corresponding to a predetermined number of channels. The input module 111 can also receive signals through the external input terminals 105.

The signal processor 112 comprises a restoration processor 221. The signal processor 112 separates program collateral information multiplexed in a received broadcast signal, outputs the separated program collateral information to the video processor 114, and also outputs a record stream to the system controller 113. The record stream is information obtained by separating, in the signal processor 112, the program collateral information from the broadcast stream received at the input module 111. The signal processor 112 separates broadcast signals (broadcast signal and resolution-enhanced broadcast signal), obtained at the input module 111, into video signals (video) (first and second TS signals), audio signals (audio) and display control information. Further, the signal processor 112 executes restoration processing on the first and second TS signals, using the restoration processor 221. The signal processor 112 outputs an audio signal to the audio processor 116. The restoration processor 221 will be described later in detail.

The system controller (system control module) 113 controls each element of the receiver 5. More specifically, the system controller 113 controls the input module 111, the signal processor 112, the video processor 114, the display 115, the audio processor 116, the audio output module 117, the DMS module 118, the operation input module 119, the receiving module 120, the communication interface 121, the network controller 122, the USB interface 123, the HDMI 124, the storage 125, etc. The system controller 113 is connected to each element of the restoration processor 221 of the signal processor 112, described later, and controls the restoration processor 221.

The system controller 113 outputs various control commands corresponding to signals (operation instruction signals) received by the receiving module 120 from a remote controller terminal (remote controller) 302, a keyboard 306, or a portable terminal, such as a smartphone, a cellular phone, a tablet, a note PC, etc. The control commands are those for instructing, for example, record of a TV broadcast (program), replay of recorded content (program), etc.

The system controller 113 also comprises a CPU 132, a read-only memory (ROM) 134, a random access memory (RAM) 136 and a non-volatile memory (NVM) 138.

The CPU 132 is a main processor for controlling the operation. Upon receiving operation information from the operation input module 119 incorporated in the main unit of the receiver 5, or receiving operation information transmitted from the remote controller 302 and received by the receiving module 120, the CPU 132 controls each element so that the operation content of the operation information will be reflected.

The ROM (read only memory) 134 stores a control program executed by the system controller 113 (CPU 132).

The RAM (random access memory (work memory)) 136 provides the system controller 113 (CPU 132) with a working area.

The NVM (nonvolatile memory) 138 stores various types of setting information and control information, etc., for the receiver 5. The nonvolatile memory 138 can store configuration content information associated with a program table.

The video processor 114 decodes a video signal (first or second display signal) obtained from the signal processor 112, and converts the decoded video signal into a signal of a predetermined resolution and an output scheme that enable the display 115 to display the signal. The video processor 114 receives a signal from the system controller 113 to thereby generate an on screen display (OSD) signal. For instance, the video processor 114 generates, as the OSD signal, a display signal for a united program table. The video processor 114 combines (multiplexes) the OSD signal with the converted video signal, and outputs the resultant synthesized video signal of these signals to the display 115. The video processor 114 may output the synthesized video signal to the output terminal of, for example, an external monitor connected as an external device, or of a projector device.

The display 115 displays a video image corresponding to the synthesized video signal from the video processor 114. When the receiving module 120 has received an operation signal from the remote controller terminal 302 or any other mobile device, the display 115 displays a video image in response to the operation signal. Also when an operation signal is output from the keyboard 306 via the USB interface 123, the display 115 can display a video image in response to the operation signal.

The audio processor 116 decodes a voice/acoustic (audio) signal of a program received by the input module 111, and outputs it to the audio output module 117.

The operation input module 119 inputs a control command corresponding to a user's direct operation to the system controller 113.

The receiving module 120 inputs a control command corresponding to an input signal from an external terminal, such as the remote controller terminal 302 or a mobile device, to the system controller 113.

The communication interface 121 realizes wireless communication with a short-range wireless communication based on, for example, Wireless Fidelity (WiFi). As a short-range wireless communication scheme, Bluetooth (trademark), Near-Field Communication (NFC), etc., are usable. The communication interface 121 may be wired or wireless, and is connected to, for example, a communication unit capable of receiving/transmitting signals from/to a wireless keyboard, a mouse, etc. Further, the communication interface 121 can communicate with, for example, a reader/writer 304 that is communicable with a noncontact card medium.

The network controller 122 controls access to an external network, such as the Internet 300. The network controller 122 executes transmission/reception of information on the Internet 300.

The USB interface 123 is connected to an external device based on the USB standards, such as the keyboard 306.

The HDMI 124 enables wired communication between a plurality of devices that utilize the HDMI standards or Mobile High-definition Link (MHL) standards.

The storage 125 is, for example, a hard disk drive (HDD), and stores various types of setting information for the receiver 5, received content, video images displayed on the display 115, etc. The storage 125 may be connected to the receiver 5 as an external device via the USB interface 123.

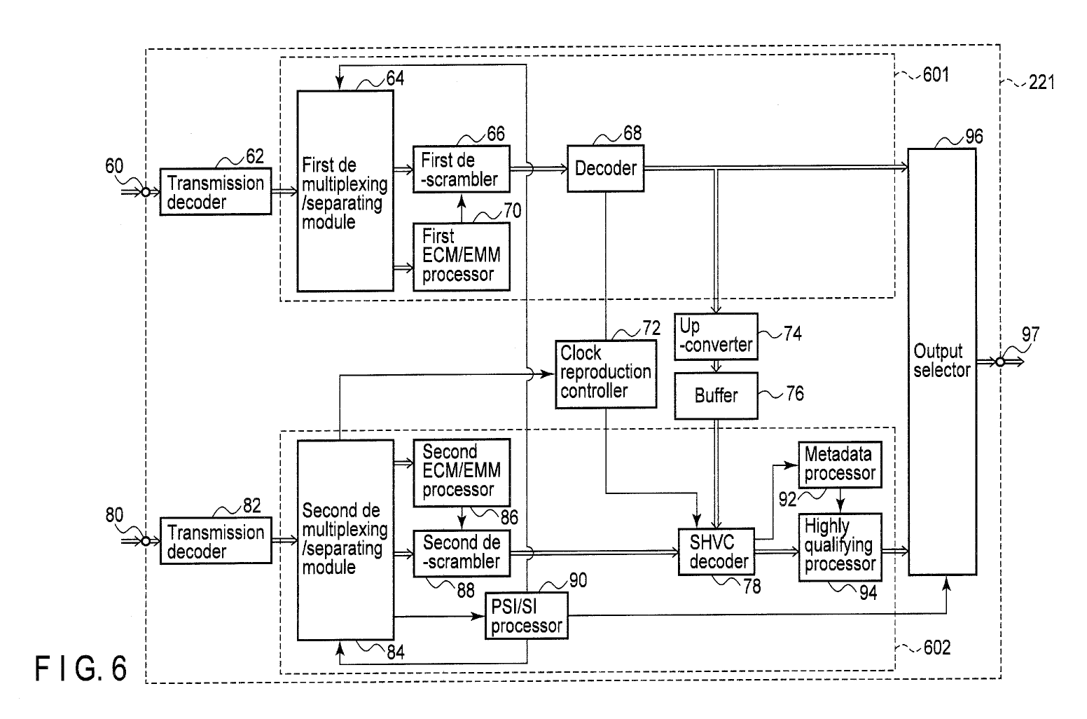

Referring then to FIG. 6, the configuration of the restoration processor 221 will be described.

FIG. 6 is a block diagram, showing an example of the restoration processor 221 incorporated in the signal processor 112 of the receiver 5.

The restoration processor 221 executes decoding processing on a broadcast signal selected by the input module 111, thereby restoring a video signal, an audio signal, subtitle/character information and program-associated information. Although the restoration processor 221 also comprises processors for audio signals, various types of information (signals), etc., these elements are not shown for simplifying description. In FIG. 6, each double line indicates the input/output of a content signal, such as a signal including a video signal, and each solid line indicates the input/output of a signal including no video signal, such as a signal including a control signal or a data signal, as in FIG. 2. In a first signal processor 601 and a second signal processor 602, a common system time clock (STC) is used.

The restoration processor 221 comprises a plurality of input terminals and transmission-path decoders for inputting various signals. More specifically, in the first embodiment, the restoration processor 221 comprises input terminals 60 and 80, transmission-path decoders 62 and 82, a clock reproduction controller 72, an up-converter 74, a buffer 76, an output selector (channel selector) 96, an output terminal 97, and the aforementioned first and second signal processors 601 and 602. The restoration processor 221 is controlled by the CPU 132. Namely, the CPU 132 controls the clock reproduction controller 72, the up-converter 74, the buffer 76, the output selector 96, the first signal processor 601, the second signal processor 602, etc.

In the embodiment, broadcast signals are input through the input terminal 60 to the transmission-path decoder 62. Resolution-enhanced broadcast signals are input through the input terminal 80 to the transmission-path decoder 82. The transmission-path decoders 62 and 82 execute decoding processing corresponding to respective transmission paths on input broadcast signals, thereby demodulating the signals. The transmission-path decoders 62 and 82 output the decoded signals (first and second TS signals).

The clock reproduction controller 72 generates second clock information for synchronization of decoding, and outputs time information obtained from a second de-multiplexing/separating module 84. Since the common STC is employed, the clock reproduction controller 72 can control the synchronization of a decoder 68 and an SHVC decoder 78, based on PCR.

The up-converter 74 up-converts the resolution, screen size and color band of an input video signal. The up-converter 74 up-converts a video signal (second decoded video signal) decoded by the decoder 68, thereby generating and outputting a video signal (second resolution-enhanced decoded video signal). For instance, the up-converter 74 up-converts the resolution of an input 2K video signal into that of a 4K video signal (second resolution-enhanced 4K video signal).

The buffer 6 is a storage area circuit for temporarily storing various signals.

The output selector 96 selects images included in an input video signal at predetermined times, based on time information, and sequentially outputs the images. The output selector 96 can output information (signal) including voice, a program table, etc., in association with the output video images. The output selector 96 outputs the selected video signal and selection information for identifying the selected video signal. In the receiver 5, the selected and output video signal is displayed on the display 115 via the video processor 114. Further, the output selector 96 can select and output a video signal in accordance with signals (instruction signals) from a PSI/SI processor 90, described later, and the CPU 132. Namely, only based on the second PSI and second SI of a resolution-enhanced video signal, the output selector 96 can select signals to be output as a main channel and a sub-channel, and can output them as selected signals (selected video signals). Further, the output selector 96 can select and output ESs included in different TSs in accordance with instruction signals from the PSI/SI processor 90 and the CPU 132. For instance, the output selector 96 can insert an image, included in a video image output as a main channel, into a video image displayed as a sub-channel and indicated by, for example, a 4K video signal. The output selector 96 can output an audio signal output as a main channel such that the audio signal corresponds to a 4K video signal displayed as a sub-channel.

The first signal processor 601 receives a first TS signal through the input terminal 60 and decodes it into a video signal (first display signal) as a main channel. Similarly, the second signal processor 602 receives a second TS signal through the input terminal 80 and decodes it into a video signal (second display signal) as a sub-channel. The first signal processor 601 decodes, for example, a first TS signal into a 2K video signal, and the second signal processor 602 decodes, for example, the decoded first TS signal (2K video signal) and a second TS signal (a resolution-enhanced video signal for 4K broadcasting) into a second high-quality video signal (4K video signal). The first signal processor 601 has substantially the same configuration as a receiver corresponding to current TV broadcasting, such as HD broadcasting. Namely, even if a current receiver, for example, a current TV receiver, is applied to the transmission/reception system 1 of the embodiment, it can receive and display an HD (2K) broadcast signal.

A description will be given of the first and second signal processors 601 and 602.

Firstly, the first signal processor 601 will be described.

The first signal processor 601 comprises a first de-multiplexing/separating module 64, a first de-scrambler 66, a first ECM/EMM processor 70 and a decoder 68.

The first de-multiplexing/separating module 64 separates an input signal into various information items (signals) and a video signal, and outputs the resultant signals. The first de-multiplexing/separating module 64 comprises a PID filter for passing therethrough only a signal that satisfies a predetermined filter condition. The first de-multiplexing/separating module 64 can set the value of the PID filter in accordance with an instruction from the CPU 132. The first de-multiplexing/separating module 64 extracts a PAT from the input signal, extracts, from the PAT, PID indicative of the PMT of the input signal and associated with the content designated by, for example, an operation signal, extracts the PMT designated by the PID, thereby extracting, from the input signal, a video signal designated by the PMT and a time information signal.

The first de-scrambler 66 executes processing for decrypting an input signal. The first de-scrambler 66 decrypts various signals encrypted using a scramble key. For instance, the first de-scrambler 66 decodes MUTI2 coding.

The first ECM/EMM processor 70 executes processing for extracting a scrambler key from the ECM and EMM of an input signal. The first ECM/EMM processor 70 decrypts the encrypted EMM, using a key unique to the receiver 5, and extracts a work key from the decrypted EMM. Subsequently, the first ECM/EMM processor 70 decrypts the ECM using the work key, and extracts the scramble key from the decoded ECM. The first ECM/EMM processor 70 outputs information indicative of the extracted scramble key.

The decoder 68 unpacks the input signal in the form of packets, and decodes the resultant signal. For instance, the decoder 68 decodes an encoded signal using MPEG-2 coding, and outputs the resultant 2K video signal.

The second signal processor 602 will now be described.

The second signal processor 602 comprises a second de-multiplexing/separating module 84, a second ECM/EMM processor 86, a second de-scrambler 88, a PSI/SI processor 90, an SHVC decoder 78, a metadata processor 92 and a highly qualifying processor 94.

The second de-multiplexing/separating module 84 separates an input signal into various information items (signals) and a video signal, and outputs the resultant signals. The second de-multiplexing/separating module 84 outputs time information included in the input signal to a clock reproduction controller. The second de-multiplexing/separating module 84 comprises a PID filter for passing therethrough only a signal that satisfies a predetermined filter condition. The second de-multiplexing/separating module 84 can set the value of the PID filter in accordance with an instruction from the CPU 132. The second de-multiplexing/separating module 84 extracts a PAT from the input signal, extracts, from the PAT, PID indicative of the PMT of the input signal and associated with the content designated by, for example, an operation signal, extracts the PMT designated by the PID, thereby extracting, from the input signal, a video signal designated by the PMT and a time information signal. If the second de-multiplexing/separating module 84 has extracted a PID value (0x1FFF) invalid for elementary_PID within the data structure of the PMT, it determines that a component in a signal of a different transmission path and a different transmission scheme is designated, and outputs determination information.

The second ECM/EMM processor 86 executes processing for extracting a scramble key from the ECM and EMM of an input signal. The second ECM/EMM processor 86 executes processing for extracting a scrambler key from the ECM and EMM of an input signal. The second ECM/EMM processor 86 decrypts the encrypted EMM, using a key unique to the receiver 5, and extracts a work key from the decrypted EMM. Subsequently, the second ECM/EMM processor 86 decrypts the ECM using the work key, and extracts the scramble key from the decrypted ECM. The second ECM/EMM processor 86 outputs information indicative of the extracted scramble key.

The second de-scrambler 88 decrypts an input encrypted signal. The second de-scrambler 88 decrypts various input encrypted signals, using, for example, a scramble key. The second de-scrambler 88 decrypts, for example, encryption based on the AES.

The PSI/SI processor 90 processes program specific information (PSI) and service information (SI) in accordance with an instruction from the CPU 132, and outputs information (signal) associated with the PSI, SI, etc. Further, the PSI/SI processor 90 reads, from the PSI, a descriptor newly defined in the PMT, and refers to the ESs of signals transmitted by different transmission paths and different transmission schemes. The PSI/SI processor 90 extracts, from the referred ESs, an ES necessary for a signal transmitted by a different transmission path and a different transmission scheme. Based on the extracted ES, the PSI/SI processor 90 generates, in accordance with an instruction signal from the CPU 132, a channel select list (channel select information) that includes a to-be-selected video signal and display timing and defines a channel select procedure and displayable content. The channel select list is information for controlling select procedures (timing) associated with a plurality of display signal as select targets, and channel select instructions. The PSI/SI processor 90 transmits and receives signals to and from the first de-multiplexing/selecting module 64, the second de-multiplexing/selecting module 84 and the output selector 96.

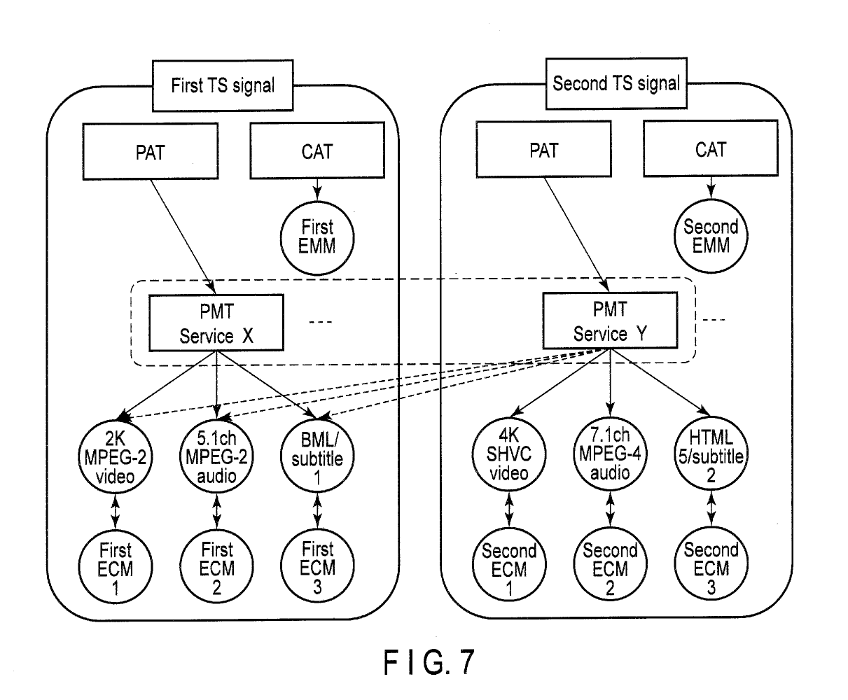

FIG. 7 is a schematic view for explaining reference to ESs between different transmission paths and transmission schemes. As shown in FIG. 7, by reading a PMT in which first channel select control information included in second PSI is written, thereby enabling equivalent processing to that performed to refer to PMTs included in PSI within different signals (TS signals), the PSI/SI processor 90 can refer to ESs included in different TS signals. Namely, the receiver 5 (i.e., the CPU 132) of the first embodiment can refer to an ES included in the first TS signal simply by referring to the PMT of the second PSI and without referring to the PMT of the first PSI. As a result, simply by referring to the PMT of the second PSI, the PSI/SI processor 90 can extract a necessary ES in accordance with an instruction from the CPU 132 and generate a channel select list based on the extracted ES. For instance, by reading the PMT (service Y) of the second PSI, the PSI/SI processor 90 can perform processing equivalent to reading the PMT (service X) of the first PSI (namely, can perform processing of the same information or service), whereby it can refer to the ES included in the first TS signal. For instance, as shown in FIG. 7, referring to the PMT (service Y) of the second TS signal, the PSI/SI processor 90 can refer to the ES included in the first TS signal, for example, a video image of the 2K MPEG-2 scheme, 5.1-channel audio of the MPEG-2 scheme, and subtitle 1.

The SHVC decoder 78 converts an input packet signal into a normal signal and decodes it. In the first embodiment, the SHVC decoder 78 decodes an input scalable encoded (SHVC (MPEG-HEVC Video) encoded) video signal. When decoding a resolution-enhanced, predicted image, the SHVC decoder 78 can execute inter-prediction (motion compensating prediction), an intra-prediction (prediction within a screen) or prediction between layers (prediction between images), in accordance with the SHVC scheme. The SHVC decoder 78 decodes a scalable signal into a resolution-enhanced video signal, using the SHVC scheme. For instance, the SHVC decoder 78 generates a high-quality video signal (pre-high-quality signal) (e.g., a 4K video signal) by subjecting a decoded resolution-enhanced, predicted video signal and a second resolution-enhanced video signal (for example, a 4K video signal) to the inter-prediction. The SHVC decoder 78 outputs the generated high-quality video signal. The SHVC encoder 44 also can generate a high-quality video signal using a prediction scheme other than the inter-prediction.

The metadata processor 92 generates, from metadata, grading information for grading contrast, color band and gradation characteristics for high-quality, and outputs the generated grading information. The metadata processor 92 generates, for example, grading information associated with 4K video images.

The highly qualifying processor 94 achieves high-quality by grading an input video signal based on the grading information. The highly qualifying processor 94 executes various types of image processing for generating high-quality video images, such as control of luminance, contrast and color band, and application of a filtering effect.

In the receiver 5 of the first embodiment, the restoration processor 221 receives broadcast signals and resolution-enhanced broadcast signals via the input terminals 60 and 80, respectively. In the restoration processor 221, the transmission-path decoder 62 subjects a broadcast signal to transmission-path decoding, and the thus-decoded signal (first TS signal) is output to the first de-multiplexing/separating module 64. Further, in the restoration processor 221, the transmission-path decoder 82 subjects a resolution-enhanced broadcast signal to transmission-path decoding under the control of the CPU 132, and the thus-decoded signal (second TS signal) is output to the second de-multiplexing/separating module 84.

In the first signal processor 601, the first de-multiplexing/separating module 64 receives only the signals filtered by the PID filter in the transmission-path decoder 62. The first de-multiplexing/separating module 64 separates the input signal into a first encrypted packet obtained by subjecting a first TS signal to transmission-path decoding, first ECM and first EMM information (signals), and the other signals. The first de-multiplexing/separating module 64 outputs the first encrypted packet to the first de-scrambler 66, and the first ECM and first EMM information (signals) to the first ECM/EMM processor 70.

The first ECM/EMM processor 70 extracts a scramble key from the first ECM and first EMM, and outputs it to the first de-scrambler 66. The first de-scrambler 66 decrypts the first encrypted packet, using the scramble key acquired from the first ECM/EMM processor 70, and outputs the decrypted packet to the decoder 68.

The decoder 68 decodes the input packet signal into a signal. More specifically, the decoder 68 decodes the input packet signal into a display signal (a first display signal, a reference video signal), such as a 2K video signal, which indicates a video signal displayed on the display 115. The decoder 68 outputs, to the up-converter 74 and the output selector 96, the decoded first display signal, such as the 2K video signal, in accordance with second clock information from the clock reproduction controller 72.

The clock reproduction controller 72 obtains time information from the second de-multiplexing/separating module 84, generates second clock information, and outputs the second clock information to the decoder 68 and the SHVC decoder 78. Since the STC is common, the clock reproduction controller 72 executes synchronization control of the decoder 68 and the SHVC decoder 78 based on PCR.

The up-converter 74 up-converts the obtained first display signal, such as a 2K video signal, into a second resolution-enhanced video signal (such as a 4K video signal), and outputs the resultant signal to the buffer 76.

In the second signal processor 602, the second de-multiplexing/separating module 84 receives only the signals filtered by the PID filter in the transmission-path decoder 82. The second de-multiplexing/separating module 84 separates the input signal into second PSI and second SI information (signals), second ECM and second EMM information (signals), a second TS signal obtained by subjecting a broadcast signal to transmission-path decoding, a time information signal, and the other signals. If the second de-multiplexing/separating module 84 has extracted a PID value (0x1FFF) invalid for elementary_PID within the data structure of the PMT, it determines that a component (ES) in a signal of a different transmission path and a different transmission scheme is designated, and outputs determination information and the second PSI and second SI information (signals) to the second PSI/SI processor 90. Further, the second de-multiplexing/separating module 84 outputs the second ECM and second EMM information (signals) to the second ECM/EMM processor 86, and outputs a second encrypted packet to the second de-scrambler 88. Yet further, the second de-multiplexing/separating module 84 outputs the time information to the clock reproduction controller 72.

The second PSI/SI processor 90 reads a descriptor newly defined under the name of “elementary_stream_reference_{—} descriptor( ),” and refers to the ES of the first TS signal based on “network_id” for allowing the reference to the ES of a different transmission path, and “transport_stream_id” for allowing the reference to the ES of a different transmission scheme. The second PSI/SI processor 90 extracts a necessary ES in accordance with an instruction signal from the CPU 132, and generates a channel select list from the extracted ES. The second PSI/SI processor 90 outputs the generated channel select list, the time information, etc., to the output selector 90.

The second ECM/EMM processor 86 extracts a scramble key from the second ECM and second EMM, and outputs it to the second de-scrambler 88. The second de-scrambler 88 decrypts the second encrypted packet using the scramble key acquired from the second ECM/EMM processor 86, and outputs the decrypted scalable packet to the SHVC decoder 78.

The SHVC decoder 78 decodes the scalable packet into a resolution-enhanced, prediction video signal, using MPEG-HEVC coding, and generates a pre high-quality video signal from the decoded prediction video signal and a second resolution-enhanced video signal (4K video signal) by inter-prediction between layers. The SHVC decoder 78 outputs metadata included in the resolution-enhanced video signal to the metadata processor 92, and outputs a pre display signal to the highly qualifying processor 94.

The metadata processor 92 generates grading information from the metadata acquired from the SHVC decoder 78, and outputs the generated grading information to the highly qualifying processor 94.

The highly qualifying processor 94 subjects the input pre high-quality signal (for example, a 4K video signal) to high-quality processing utilizing grading based on grading information, and outputs the resultant high-quality video signal (a second display signal, a high-quality video signal, a second high-quality video signal) (such as a 4K video signal) to the output selector 96.

The output selector 96 selects, at predetermined display times, image signals included in the input first display signal (2K video signal) and the second display signal (4K video signal (the second high-quality video signal)), based on the channel select list and time information generated by the PSI/SI processor 90, and outputs them via the output terminal 97. Further, the output selector 96 receives a channel select list signal from the PSI/SI processor 90, selects the first display signal (2K video signal) and the second display signal (4K video signal) in accordance with the channel select list and/or an instruction signal from the CPU 132, and outputs the selected signals (selected video signals).

A description will now be given of, channel selection processing by the receiver 5.

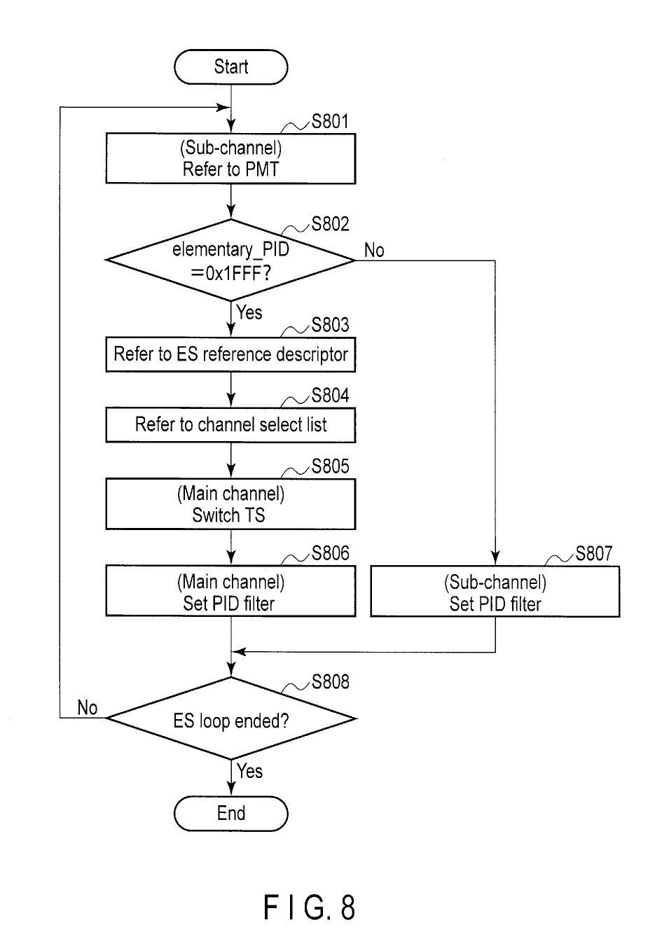

FIG. 8 is a flowchart for explaining an example of channel select processing performed by the receiver 5 of the first embodiment.

When the receiver 5 has received a broadcast signal and a resolution-enhanced broadcast signal from the transmitter 3, the second de-multiplexing/separating module 84 of the restoration processor 221 refers to the PMT of the second TS signal in accordance with an instruction from the CPU 132 in S801.

When the PMT of the second TS signal has been referred to, the CPU 132 determines in S802 whether elementary_PID is 0x1FFF. If the elementary_PID is 0x1FFF (Yes in S802), the PSI/SI processor 90 refers to an ES reference descriptor (first channel select control information) in the first TS signal in accordance with an instruction from the CPU 132, thereby extracting a necessary ES. The PSI/SI processor 90 generates a channel select list from the extracted ES, and outputs it to the output selector 96.

If the elementary_PID is not 0x1FFF (No in S802), the second de-multiplexing/separating module 84 sets a PID filter in S807, thereby filtering the second TS signal.

In S804, the output selector 96 refers to the channel select list in accordance with an instruction from the CPU 132, and selects a 2K video signal (a reference video signal, a first display signal) and a high-quality video signal (a reference video signal, a second display signal) in accordance with the channel select list. The output selector 96 outputs the selected video signals to the display 115. In S805, the CPU 132 causes the decoder 68 to switch the main channel TS. In S806, the first de-multiplexing/separating module 64 sets the PID filter to filter the first TS signal.

In S808, the CPU 132 determines whether an ES loop in the PMT is finished. If the ES loop in the PMT is finished (Yes in S808), the receiver 5 finishes channel select processing. In contrast, if the ES loop in the PMT is not finished (No in S808), the receiver 5 returns to initial processing (S801), thereby iterating a series of processing described above.

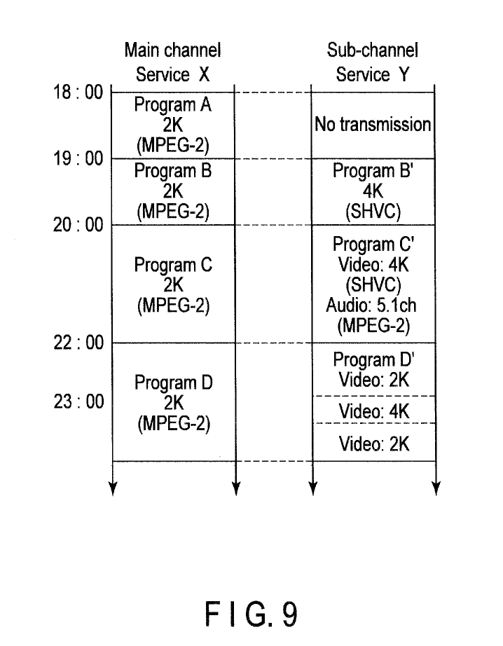

FIG. 9 is a schematic view showing an example of a relationship between a main channel and a sub-channel in the first embodiment.

In the transmission/reception system 1 of the first embodiment, since first channel select control information is newly defined as predetermined video signal information (signal) for the second TS signal that constitutes a sub-channel (signal), the receiver 5 can output a combination of various signals as the sub-channel.

If the first channel select control information cannot be read as in program A in FIG. 9, the receiver 5 determines that no resolution-enhanced video signal is transmitted, a main channel (program A) is displayed.

If the first channel select control information can be read as in program B in FIG. 9, the receiver 5 can display program B as the main channel, and can display program B′ as the sub-channel. In this case, program B is a 2K video program, and program B′ is a 4K video program.

If the first channel select control information can be read as in program C in FIG. 9, the receiver 5 can also freely set a combination of output components in accordance with instruction signals from the remote controller 302 and the CPU 132. For instance, the receiver 5 can output an audio signal included in the TS of the main channel, while a 4K video program is displayed as the sub-channel.

Similarly, if the first channel select control information can be read as in program D in FIG. 9, the receiver 5 can also freely set a combination of output components in accordance with instruction signals from the remote controller 302 and the CPU 132. For instance, the receiver 5 can replace part of a 2K video program with a 4K video program or commercial as the sub-channel.

Further, the receiver 5 can select and display the main and sub-channels in accordance with instruction signals from the remote controller 302 and the CPU 132.

In the transmission/reception system 1 according to the first embodiment, the transmitter 3 provides a resolution-enhanced video signal as a sub-channel with channel select control information that enables all necessary ESs (of main and sub signals) to be referred to when the channel select control signal is extracted. Since the transmitter 3 provides a resolution-enhanced video signal as a sub-channel with channel select control information that enables all necessary ESs (of main and sub signals) to be referred to when the channel select control signal is extracted, it is sufficient if the receiver 5 executes processing referring to only one of the TSs. In other words, the receiver 5 does not have to refer to the other TS. As a result, the transmission/reception system 1 of the first embodiment can smoothly and efficiently execute channel selection processing corresponding to high-quality broadcasting.

Further, in the transmission/reception system 1 of the first embodiment, the first signal generator 501, for example, may process substantially the same broadcast services as the current broadcast services. Thus, the transmission/reception system 1 of the first embodiment is compatible with a conventional transmission/reception system directed to current broadcast services, such as HD broadcast services. More specifically, in the transmission/reception system 1 of the first embodiment, a receiver compliant with a current broadcast, such as an HD broadcast, can receive a reference video signal from the transmitter 3, and can display an HD video program, while a receiver compliant with a high-quality video broadcast, such as a 4K video broadcast, can receive a reference video signal and a resolution-enhanced video signal from the transmitter 3, and can smoothly and efficiently display a 4K video image, referring to channel select control information. Accordingly, the transmission/reception system 1 has a weak possibility of causing a failure in reception, such as an unexpected operation, in an existing-broadcast-compliant receiver.

Transmission/reception systems according to other embodiments will be described. In the other embodiments, elements similar to those of the first embodiment are denoted by corresponding reference numbers, and no detailed description will be given thereof.

### Second Embodiment

In a second embodiment, the transmitter 3 further comprises a newly-defined service group descriptor.

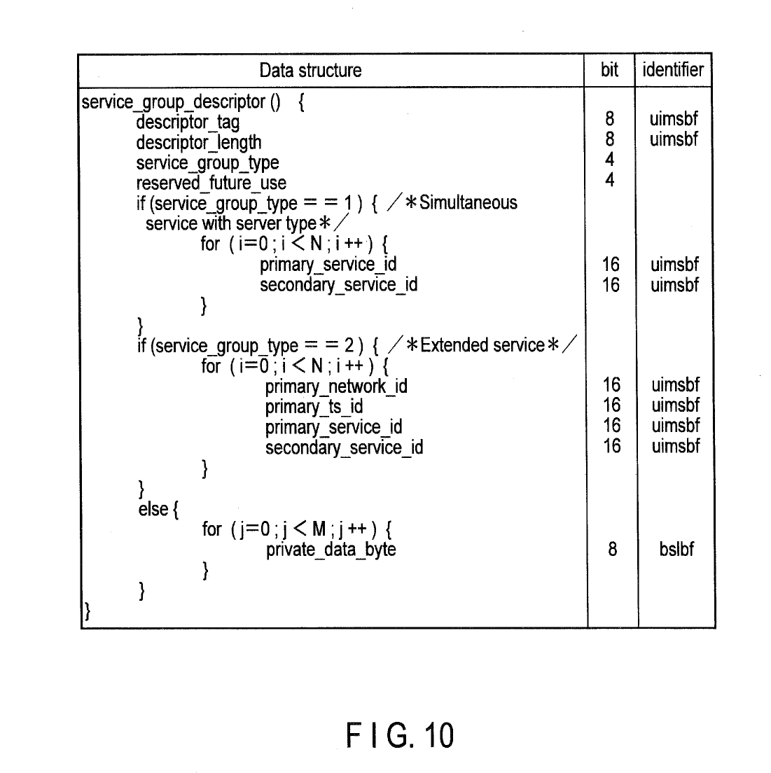

FIG. 10 is a view showing an example of a data structure of the newly-defined service group descriptor.

In the transmitter 3 of the second embodiment, the second PSI/SI generator 50 writes a descriptor (second channel select control information (second channel select control descriptor)) that newly associates an NIT, included in the PMT of the second PSI, with main and sub-channels. The second PSI/SI generator 50 newly writes “if(service_group_type==2){ }” (second channel select control information (second channel select control descriptor)) indicative of an extended service (resolution-enhanced channel), in “service_group_descriptor( ){ }” as a service group descriptor (NIT) for a broadcast and communication network (transmission path). The descriptor for the extended service includes “primary_network_id” indicative of with which transmission-path the service is associated, and “primary_ts_id” indicative of with which transmission-scheme (for example, TS) the service is associated. Namely, merely referring to (the second channel select control information included in) the PMT of the second PSI, the receiver 5 (CPU 132) can identify a signal transmitted by an associated different transmission path and/or scheme.

A description will be given of processing of generating a channel select list for the receiver 5.

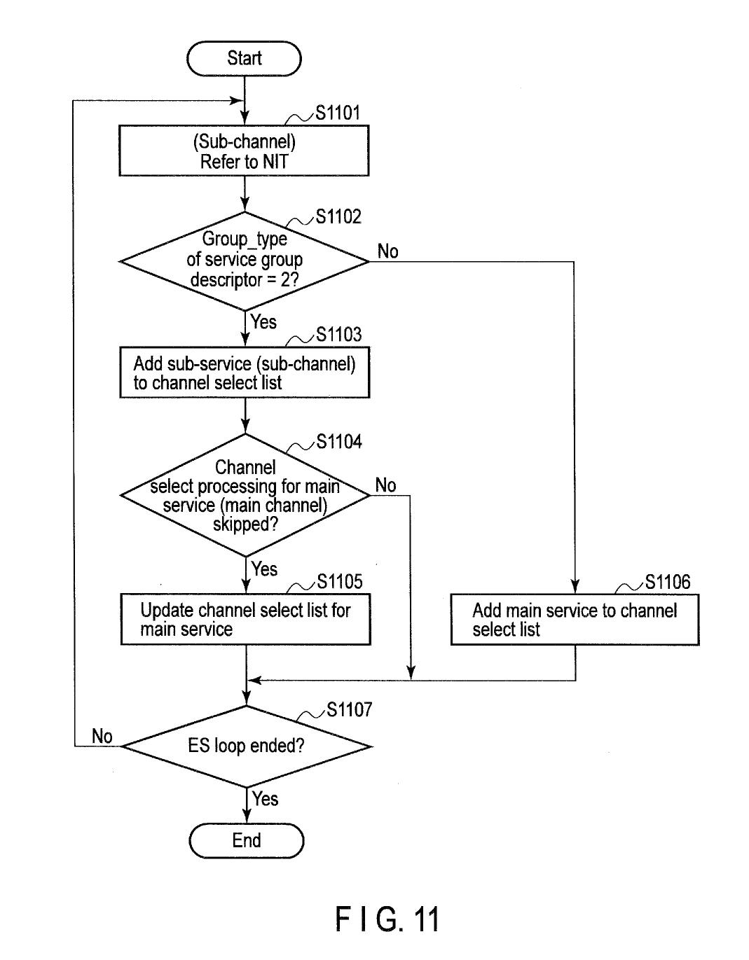

FIG. 11 is a flowchart for explaining an example of channel select list generation processing in the receiver 5 of the second embodiment.

When the receiver 5 has received a broadcast signal and a resolution-enhanced broadcast signal from the transmitter 3, the second de-multiplexing/separating module 84 of the restoration processor 221 refers to an NIT included in the PMT of the second TS signal in accordance with an instruction from the CPU 132 (S1101).

When the NIT of the second TS signal has been referred to, the CPU 132 determines in S1102 whether “if(service_group_type==2){ }” (second channel select control information) exists. If group_type=2 of the NIT is designated, the CPU 132 determines that the received signal contains resolution-enhanced data (second TS signal) and is therefore associated with a sub service. As a result, the CPU 132 can also identify a signal (first TS signal) corresponding to a main service associated with the sub service.

If, “if(service_group_type==2){ }” exists (Yes in S1102), the PSI/SI processor 90 adds, in S1103, a sub service as a channel select target to the channel select list and outputs the resultant list to the output selector 96, in accordance with an instruction from the CPU 132.

In contrast, if, “if(service_group_type==2){ }” does not exist (No in S1102), the PSI/SI processor 90 adds, in S1106, a main service as a channel select target to the channel select list and outputs the resultant list to the output selector 96, in accordance with an instruction from the CPU 132, thereby proceeding to S1107.

In S1104, the CPU 132 determines whether channel select processing associated with the main service should be skipped. If it is determined that the channel select processing associated with the main service should be skipped (Yes in S1104), the PSI/SI processor 90 adds, to a predetermined signal, information indicating that selection of the main service should be skipped (excluded), using the second channel select control information, thereby updating the channel select list to skip the information-added signal (S1105). For instance, if in S1103, the skip of the main service corresponding to the sub service added to the channel select list in S1103 is designated by an operation signal output from the CPU 132 of the receiver 5 or input by a user, the PSI/SI processor 90 adds information indicating the skip of the selection of the main service, using the second channel select control information, thereby updating the channel select list.

In contrast, if the selection of the main service is not skipped (No in S1104), the PSI/SI processor 90 does not update the channel select list using the second channel select control information, in accordance with an instruction from the CPU 132. In this case, if the selection of the main service is designated by an operation signal output from the CPU 132 or input by a user, the output selector 96 shifts channel select processing to the sub service. Namely, the output selector 96 selects the sub service when the selection of the main service is designated, and then proceeds to S1107.

In S1107, the CPU 132 determines whether the ES loop in the PMT is finished. If the ES loop in the PMT is finished (Yes in S1107), the receiver 5 finishes channel select processing. In contrast, if the ES loop in the PMT is not finished (No in S1107), the receiver 5 returns to the initial processing (S1101), thereby iterating a series of processing described above.

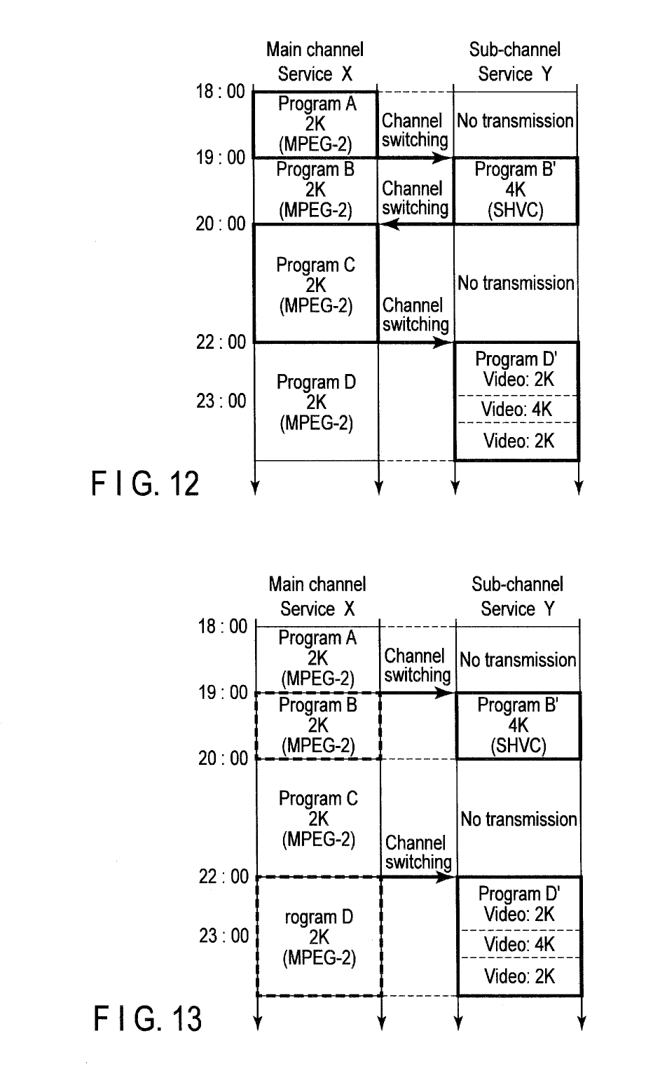

FIGS. 12 and 13 show relationship examples between channel select control processing associated with the main channel and that associated with the sub-channel in the second embodiment. In FIGS. 12 and 13, it is assumed that the receiver 5 is, for example, a 2K/4K-compatible receiver (TV).

In the transmission/reception system 1 of the second embodiment, since second channel select control information is newly defined as predetermined information (signal) in a main and sub-channel associating descriptor in the second TS signal constituting the sub-channel, the receiver 5 can output various combinations of signals as sub-channel information.

When the answer in S1104 of FIG. 11 is Yes, and the main channel is excluded from the channel select list in S1105 of FIG. 11, if the receiver 5 determines that a resolution-enhanced video signal constituting the sub-channel (program B′) is transmitted, it automatically skips selection of the main channel (programs B and D) and the display is switched to the sub-channel (programs B′ and D′) under the control of the CPU 132, as is shown in FIG. 12.

In contrast, when the answer in S1104 of FIG. 11 is No, and the main channel is not excluded from the channel select list, if the user designates the display of the main channel (programs B and D) using the remote controller 302, the receiver 5 automatically displays the sub-channel (programs B′ and D′) under the control of the CPU 132, as is shown in FIG. 13.

In the second embodiment, the transmitter 3 includes a newly defined service group descriptor (NIT) that associates the main channel with the sub-channel. Accordingly, the receiver 5 (CPU 132) can identify the second TS signal constituting the sub-channel (sub service), referring to the NIT, and can also identify the first TS signal constituting the main channel (main service) associated with the sub-channel and transmitted by a different transmission path and/or a different transmission scheme. Namely, the receiver 5 can identify an associated signal of a different transmission path and/or a different transmission scheme, merely referring to the PMT of the second PSI. As a result, the receiver 5 can execute efficient channel selection control.

### Third Embodiment

A transmission/reception system 1 according to a third embodiment is substantially the same in structure as the systems of the above-described embodiments. Therefore, elements similar to those of the above-described embodiments are denoted by corresponding reference numbers, and no detailed description will be given thereof.

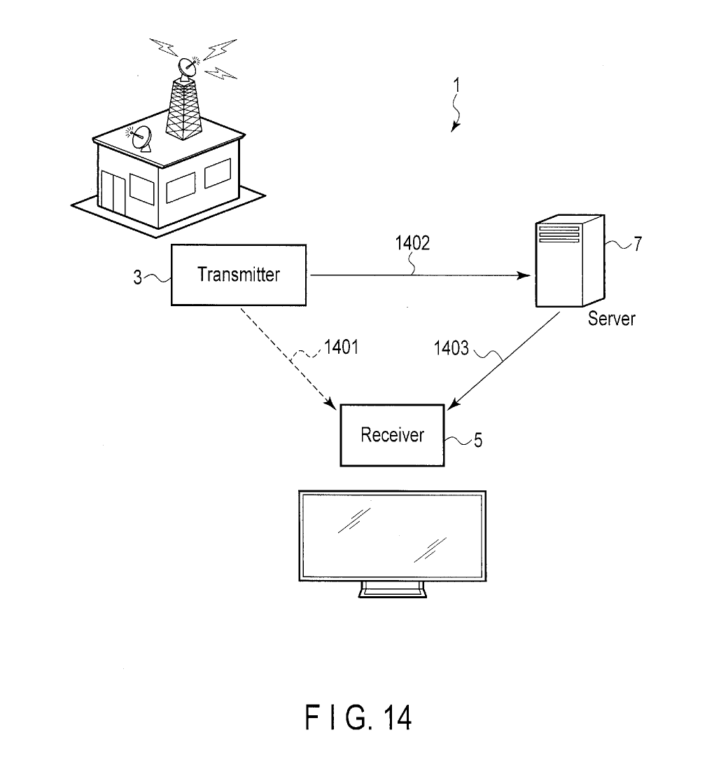

FIG. 14 is a schematic view showing the transformation/reception system 1 of the third embodiment. The transformation/reception system 1 of the third embodiment has substantially the same structure as the above-described embodiments.

The transformation/reception system 1 of the third embodiment comprises a server 7, in addition to the elements of the above-described embodiments. Accordingly, the transformation/reception system 1 of the third embodiment comprises a first transmission path 1401, a second transmission path 1402 and a third transmission path 1403. The first to third transmission paths 1401 to 1403 may each comprise a plurality of transmission paths.

The first transmission path 1401 is a broadcast line for transmitting broadcast and satellite broadcast signals. The second and third transmission paths 1402 and 1403 are wired and wireless communication lines, such as the Internet (IP network).

In the transformation/reception system 1 of the third embodiment, the server 7 accumulates program content supplied from the transmitter 3 via the second transmission path 1402 by wired or wireless communication. Further, the receiver 5 can access the server 7 by wired or wireless communication via the third transmission path 1403 and a network, such as a network controller 122 and the Internet. In the transformation/reception system 1, the receiver 5 has, for example, a so-called IP broadcast function of acquiring content distributed from the server 7 based on a preset program distribution schedule, and outputting correcting video and audio signals, and a so-called video-on-demand function (VOD) of acquiring requested program content from the server 7 and outputting corresponding video and audio signals.

The receiver 5 can receive content distributed by broadcasting or communication from the transmitter 3 and/or the server 7, and can display the received content on the display 115. At this time, under control of the CPU 132, the receiver 5 acquires a reference video signal via the first transmission path 1401 and acquires a resolution-enhanced video signal via the first transmission path 1401 and/or the third transmission path. The receiver 5 processes the acquired reference video signal and the resolution-enhanced video signal in the same way as in the above-described embodiments, and displays them on the display 115.

The transformation/reception system 1 of the third embodiment comprises the server 7. As a result, it can realize a greater number of combinations of displays for the sub-channel, than in the afore-described embodiments.

A modification of the third embodiment will be described. In the modification, elements similar to those of the above embodiments are denoted by corresponding reference numbers, and no detailed description will be given thereof.

(Modification)

A transformation/reception system 1 according to a modification of the third embodiment comprises first, second and third transmission paths 1401, 1402 and 1403 each including a plurality of transmission paths. For instance, in the transformation/reception system 1 of the modification, the first transmission path 1401 includes a plurality of transmission paths, such as a simulcast broadcast path and a scalable broadcast path. The signals generated by the transmitter 3 are output to a plurality of transmission paths included in each of the first, second and third transmission paths 1401, 1402 and 1403. At this time, the signals output to the plurality of transmission paths are transmitted by different transmission schemes and/or the same transmission scheme. Further, the transformation/reception system 1 of the modification is assumed to be compatible with both simulcast broadcasting and scalable broadcasting.

In the modification, at least one signal converted using SHVC coding is output to one of the transmission paths included in each transmission path 1401, 1402 or 1403. As coding schemes, the transmitter 3 may employ, for example, High-efficiency Video Coding (HEVC), as well as MPEG-2 coding. Further, the receiver 5 comprises a plurality of tuners and signal processors corresponding to the transmitter 3. In the transmitter 3, the first signal generator 501 generates a video signal corresponding to the current broadcasting (2K broadcasting), and the first signal processor 601 processes a video signal in accordance with the current broadcasting (2K broadcasting).

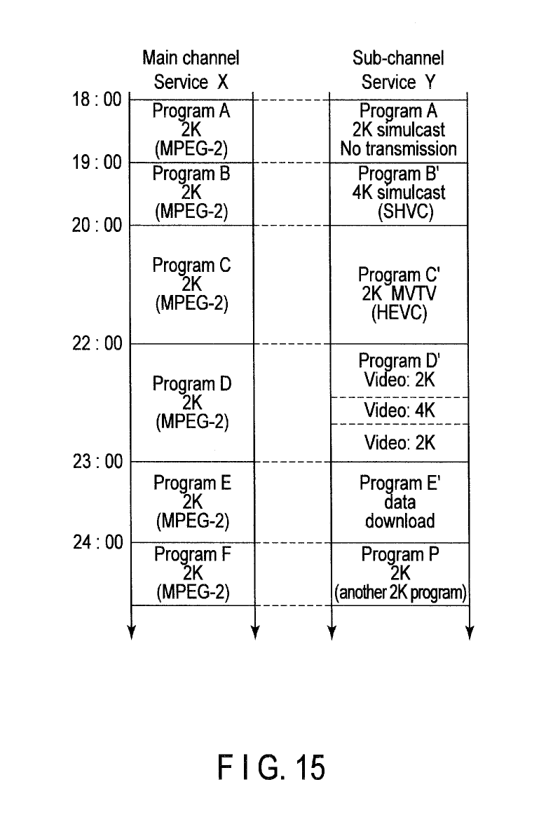

Referring then to FIG. 15, a description will be given of a relationship example between the main channel and the sub-channel according to the modification.

FIG. 15 is a schematic view showing the relationship example between the main channel and the sub-channel in the modification. In FIG. 15, the receiver 5 is assumed to be, for example, a 2K/4K compatible receiver (TV). As the main channel, the receiver 5 outputs a 2K video signal to be transmitted by, for example, MPEG-2 coding.

As shown in FIG. 15, the receiver 5 of the modification provides various ways of display for the sub-channel. The receiver 5 can selectively output the main channel and the sub-channel in accordance with instruction signals from the remote controller 302 and the CPU 132. The CPU 132 causes the PSI/SI processor 90 to generate various channel select lists, and performs switching between the main channel and the sub-channel in accordance with a desired one of the channel select lists.

As shown in FIG. 15, the receiver 5 of the modification outputs only the main channel (program A) when there is no transmission of the sub-channel.

As shown in FIG. 15, as the sub-channel (program B′) corresponding to the main channel (program B), the receiver 5 can output a 4K video signal to be transmitted by simulcast broadcasting of SHVC coding.

As shown in FIG. 15, the receiver 5 of the modification can output a 2K-broadcast multi-view TV (MVTV) as the sub-channel (program C′) corresponding to the main channel (program C).

As shown in FIG. 15, the receiver 5 of the modification can output video signals, which comprise a 2K video signal and a 4K video signal, as the sub-channel (program D′) corresponding to the main channel (program D).

As shown in FIG. 15, the receiver 5 of the modification can download a video signal via the third transmission path 1403 as the sub-channel (program E′) corresponding to the main channel (program E), and can output the downloaded video signal.

As shown in FIG. 15, the receiver 5 of the modification can output a video signal, associated with a program different from a main-channel program (program F), as the sub-channel (program P) corresponding to the main channel (program F).

In the modification, the transformation/reception system 1 comprises a plurality of transmission paths, such as the simulcast broadcast path, the scalable broadcast path and the Internet communication line, between the transmitter 3, the receiver 5 and the server 7. Accordingly, the receiver 5 can provide various broadcast services. For instance, the receiver 5 can flexibly and easily use extended services of a wider range, such as a simulcast broadcast service along with the HD broadcast service, pseudo simulcast broadcast service in which only a signal format, such as resolution, differs, a multi-view MVTV) service, such as addition of sub-video transmission using the sub-channel, and CM replacement.

In the transformation/reception system 1 according to the above-described embodiments, the transmitter 3 provides a resolution-enhanced video signal as the sub-channel with channel select control information that enables all necessary ESs (of main and sub signals) to be referred to when the channel select control signal is extracted. Since the transmitter 3 provides a resolution-enhanced video signal as the sub-channel with channel select control information that enables all necessary ESs (of main and sub signals) to be referred to when the channel select control signal is extracted, the receiver 5 only has to execute processing referring to a PMT included in one of the TS signals, and does not have to execute processing referring to a PMT included in the other TS signal. As a result, the transformation/reception system 1 according to the embodiments can smoothly and efficiently execute channel select processing corresponding to high-quality broadcasting.

Further, in the transformation/reception system 1 according to the above-described embodiments, the first signal generator 501 may have substantially the same configuration as a configuration corresponding to the current broadcasting. Thus, the transformation/reception system 1 according to the embodiments is compatible with a system corresponding to the current broadcast services, such as HD broadcast services. Therefore, the transformation/reception system 1 has a weak possibility of causing a failure in reception, such as an unexpected operation, in an existing-broadcast-compliant receiver.

Although in the above-described embodiments, the first signal generator 501 employs MPEG-2 coding and the second signal generator 502 employs SHVC coding, the first and second signal generators 501 and 502 may employ the same coding scheme or other coding schemes. In this case, the first and second signal processors 601 and 602 are configured to execute decoding processing suitable for the coding scheme of each signal to be processed.

Further, although the above-described embodiments each employ a single main channel and a single sub-channel, they may employ pairs of main channels and sub-channels.

Yet further, although in the embodiments, the first signal generator 501 generates a main channel signal corresponding to HD broadcasting, and the second signal generator 502 generates a sub-channel signal corresponding to 4K broadcasting, they may generate video signals corresponding to broadcasting of other resolutions. For instance, the second signal generator 502 generates a sub-channel signal corresponding to 8K broadcasting. In this case, the first and second signal processors 601 and 602 are configured to execute decoding processing suitable for broadcast signals sent from the transmitter 3.

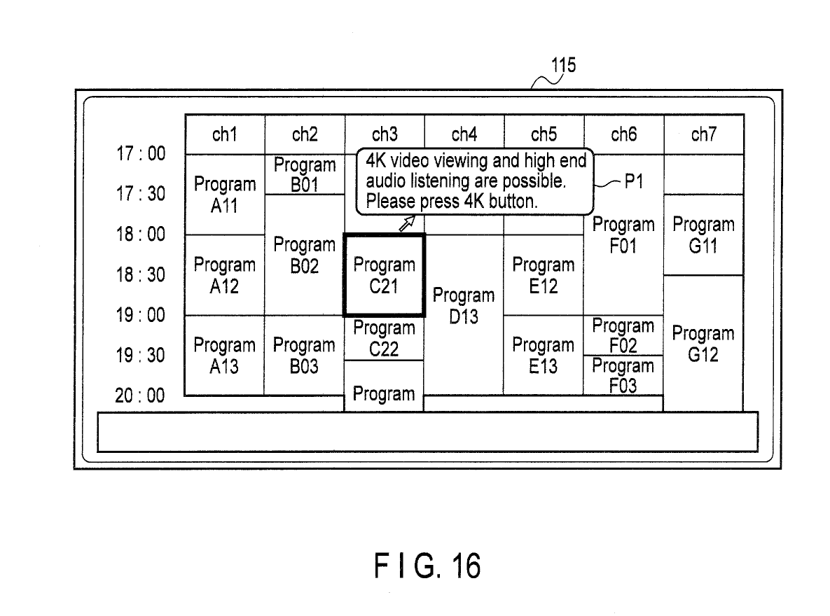

In the embodiments, when the existence of a resolution-enhanced video signal is confirmed, the receiver 5 can display a pop-up on a program table. FIG. 16 shows an example of an electronic program guide (EPG) screen as a program table in the receiver 5.

Although in the embodiments, the transmitter 3 is configured to convert content into a plurality of signals and transmit them by different transmission paths that are included in a single transmission path (1401, 1402 and 1403).

Although in the embodiments, the transmitter 3 transmits a plurality of signals using different transmission schemes, the signals may be transmitted using a single transmission scheme.

When a user has operated the remote controller 302 to set a cursor to a desired program and press a decision button, the receiver 5 selects the program selected by the user, and displays it.

For instance, when the receiver 5 has confirmed via the CPU 132 that a sub-channel (resolution-enhanced video signal) exists in program C21, namely, that a 4K video image can be viewed, it displays a pop-up. The receiver 5 may display comments in the pop-up. For instance, as shown in FIG. 16, the receiver 5 displays a message that “4K viewing is possible. Please press a 4K button on the remote controller.” In this case, if the user has pressed, for example, the 4K button (not shown), the receiver 5 displays a 4K video image corresponding to the sub-channel. By thus displaying a pop-up, the user can easily recognize that a resolution-enhanced video signal exists, as well as a reference video signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmission apparatus comprising:
a control information generator for generating channel select control information indicative of configuration information for transmission, the configuration information comprising content included in a first video signal transmitted via a different transmission path than a second video signal; and
a multiplexer that multiplexes the second video signal and the channel select control information, the second video signal obtained based at least in part on a base video signal, the second video signal corresponding to the channel select control information.

2. The apparatus of claim 1, wherein the control information generator generates a first select control descriptor included in the channel select control information indicative of the configuration information, which is designated in the first video signal transmitted by a transmission scheme different from a transmission scheme of the second video signal.

3. The apparatus of claim 1, wherein the channel select control information generator generates a first select channel control descriptor in a program map table in the channel select control information, the first select channel control descriptor indicative of an elementary system designated in the first video signal transmitted by a transmission path different from a transmission path of the second video signal, and/or with a transport stream of a signal different from a transport stream of the second video signal.

4. The apparatus of claim 3, wherein the channel select control information generator generates information which designates 0x1FFF in an elementary packet ID field in the program map table in the channel select control information indicating that the elementary system of the second video signal is not designated, the second video signal transmitted by a single transmission path and with a single transport stream.

5. The apparatus of claim 4, wherein the channel select control information generator generates a second select channel control descriptor in the channel select control information indicative of association between the first video signal and the second video signal in a network information table.

6. The apparatus of claim 4, further comprising:
a resolution-enhanced signal generator configured to generate the second video signal based at least in part on inter-image prediction between the base video signal and a video signal different from the base video signal, and to output the second video signal to the multiplexer.

7. A transceiver system comprising a transmission apparatus and a receiving apparatus,
wherein
the transmission apparatus comprises:
a first signal generator configured to receive a base video signal comprising configuration information constituting content, to convert the base video signal into a first video signal, and to output the first video signal;
a channel select control information generator configured to generate channel select control information indicative of configuration information for transmission, the configuration information of the first video signal transmitted via a different transmission path from a second video signal; and
a multiplexer configured to multiplex a second video signal and the channel select control information, the second video signal obtained based at least in part on a base video signal, corresponding to the channel select control information
the receiving apparatus comprises:
a first processor configured to input the first video signal, to convert the first video signal into a first display signal, and to output the first display signal;
a second processor configured to input the second video signal, to convert the second video signal into a second display signal, and to output the second display signal;
a channel select information processor configured to read the channel select control information in the second video signal, to generate channel select information indicative of a video image selected from the first video signal with reference to the configuration information, and to output the channel select information; and
a channel selector configured to input the channel select information, and to output the first and/or second display signals in accordance with the channel select information.

8. The system of claim 7, wherein the channel select control information generator generates a first select control descriptor included in the channel select control information indicative of the configuration information designated in the first video signal transmitted by a transmission scheme different from a transmission scheme of the second video signal.

9. The system of claim 7, wherein the channel select control information generator generates a first select channel control descriptor in a program map table in the channel select control information, the first select channel control descriptor indicative of an elementary system designated in the first video signal transmitted by transmission path different from a transmission path of the second video signal, and/or with a transport stream of a signal different from a transport stream of the second video signal.

10. The system of claim 9, wherein the channel select control information generator generates a second select channel control descriptor in the channel select control information indicative of association between the first video signal and the second video signal in a network information table.

11. The system of claim 10, wherein when detecting, in the channel select information, information indicative of existence of the second video signal corresponding to the first video signal, the channel selector excludes the first video signal from channel selection.

12. The system of claim 10, wherein when detecting, in the channel select information, information indicative of existence of the second video signal corresponding to the first video signal, the channel selector selects the second display signal when the first display signal is designated.

13. The system of claim 10, further comprising:
a resolution-enhanced signal generator configured to generate the second video signal based at least in part on inter-image prediction between the base video signal and a video signal different from the base video signal, and to output the second video signal to the multiplexer.
